(19) United States
(12) Patent Application Publication
(10) Pub. No.: US 2009/0196144 A1
(43) Pub. Date: Aug. 6, 2009

(54) Method and System for Command-Ordering and Command-Execution Within a Command Group for a Disk-to-Disk-to-Holographic Data Storage System

(76) Inventors: Nils Haustein, Soergenloch (DE); Craig A. Klein, Tucson, AZ (US); Ulf Troppens, Mainz (DE); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 12/027,045

(22) Filed: Feb. 6, 2008

(51) Int. Cl. G11B 7/00

(52) U.S. Cl. 369/103

(57) ABSTRACT

A system, method and computer program product for managing command ordering and command execution for a host-Disk-to-intermediate-Disk-to-Holographic (D2D2H) data storage system. Specifically, a command ordering and execution (COE) utility selects the command group from a command queue. A determination is made whether the command group includes a write command for writing an entire hologram segment. Responsive to a determination that the command group does not include the write command for writing the entire hologram segment, the entire hologram segment is read to an intermediate system disk. Conflicting commands are then sorted from non-conflicting commands. Specifically, all conflicting write commands are executed before all conflicting read commands. After execution, the entire hologram segment of the intermediate system disk is closed and written in holographic medium.

### BACKGROUND OF THE INVENTION

1. Technical Field

The present invention generally relates to a data processing system and in particular to a system for managing command-ordering and command-execution for a host-Disk-to-intermediate-Disk-to-Holographic (D2D2H) data storage system.

2. Description of the Related Art

Existing host-Disk-to-intermediate-Disk-to-Holographic (D2D2H) data storage systems can have multiple host systems interfacing with a holographic storage system. Each host disk may try to either: (i) read data from or (ii) write data to hologram segments of a holographic storage system. In this regard, there can be multiple host disks that reference data to be read from or written to the same hologram segment or to different hologram segments.

A problem arises in D2D2H systems when multiple competing host systems try to access the same hologram segment simultaneously, but with conflicting commands. One example of a conflicting commands scenario is when a first host system wants to read data, while a second host system wants to simultaneously write data to the same hologram segment. Such a scenario can jeopardize data integrity. This problem is exacerbated if the host systems are attempting to access a closed hologram segment (i.e., a hologram segment that resides in holographic media) that is stored in a tertiary storage holographic device.

Tertiary holographic storage or tertiary holographic memory is a holographic memory storage system, whereby a robotic arm will mount (insert) and dismount (remove) a removable holographic media cartridge to/from a holographic device according to the system's demands. Tertiary holographic storage can be used for archiving rarely accessed information, since the time to access tertiary holographic storage is longer than that of secondary storage. Tertiary holographic storage is especially useful for extraordinarily large data stores which are accessed without human operators.

However, the process by which such type of tertiary holographic storage is accessed is time consuming. For example, when a host system reads information stored in tertiary holographic storage, the host system will typically consult a catalog database to determine which holographic media cartridge contains the hologram segment, which in turn, contains the information in question. Next, the host system will instruct a robotic arm to fetch the holographic media cartridge and insert the holographic media cartridge in the holographic drive. A read command is then sent by the host system to the holographic drive, and the command is then applied to the holographic media cartridge containing the holographic media in question. When the host system has finished reading the information, the host will then instruct the robotic arm to return the holographic media cartridge to its place in the library immediately, or when access to another holographic media cartridge is requested.

In the case of a host system requesting a write command, the requested information that is stored in the closed hologram segment must then be emulated onto an intermediate disk as an open hologram segment in order to be written to by the host system. In addition to the time resources that are consumed in accessing (i.e., reading from or writing to) hologram segments in holographic media, there are typically a limited number of holographic drives to process all read/write (R/W) requests by the various host systems.

### SUMMARY OF AN EMBODIMENT

Disclosed is a system, method and computer program product for command-ordering and command-execution for a host-Disk-to-intermediate-Disk-to-Holographic (D2D2H) data storage system. Specifically, a command ordering and execution (COE) utility selects the command group from a command queue. A determination is made whether the command group includes a write command for writing an entire hologram segment. Responsive to a determination that the command group does not include the write command for writing the entire hologram segment, the entire hologram segment is read to an intermediate system disk. Conflicting commands are then sorted from non-conflicting commands. All non-conflicting commands are then executed. Specifically, all conflicting write commands are executed before all conflicting read commands. After completion of execution of conflicting commands and non-conflicting commands, the entire hologram segment of the intermediate system disk is closed and written in a holographic medium.

The above as well as additional objectives, features, and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a data processing system within which the features of an illustrative embodiment may be advantageously implemented;

FIG. 2 is block diagram of a host-Disk-to-intermediate-Disk-to-Holographic (D2D2H) data storage system that is useful for understanding the invention;

FIG. 3 is a flowchart of exemplary method steps for command ordering in a D2D2H data storage system, according to an illustrative embodiment; and

FIG. 4 is a flowchart of exemplary method steps for the execution of commands within a D2D2H data storage system, according to an illustrative embodiment.

### DETAILED DESCRIPTION OF AN ILLUSTRATIVE EMBODIMENT

Disclosed is a system, method and computer program product for command-ordering and command-execution for a host-Disk-to-intermediate-Disk-to-Holographic (D2D2H) data storage system. In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is also understood that the use of specific parameter names are for example only and not meant to imply any limitations on the invention. The invention may thus be implemented with different nomenclature/terminology utilized to describe all parameters and/or associated features that are provided herein, without limitation.

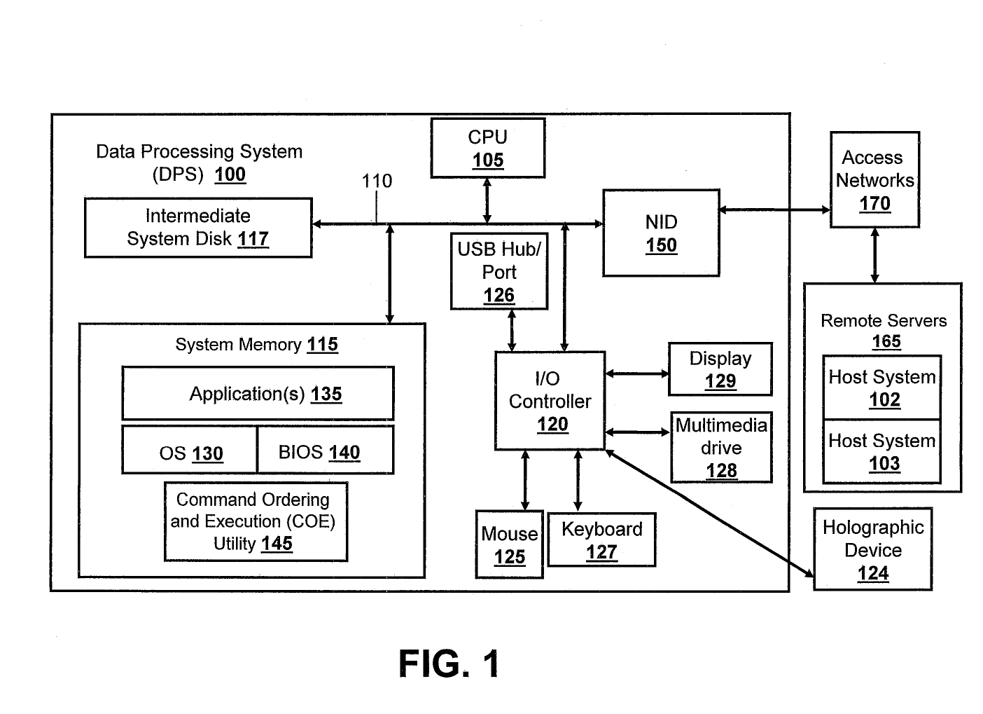

With reference now to FIG. 1, depicted is a block diagram representation of data processing system (DPS) 100 within which features of the invention are implemented. DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, multimedia drive 128 (e.g., CDRW or DVDRW drive) and Universal Serial Bus (USB) hub/port 126 are illustrated, coupled to I/O controller 120. Multimedia drive 128 and USB hub/port 126 may operate as both input and output mechanisms for inserting removable storage devices therein. External to DPS 100, holographic device 124 is peripherally connected to I/O controller 120. Holographic device 124 operates as a storage medium to which data can be read from or written to DPS 100 also comprises intermediate system disk 117, within which data/instructions/code may be stored. DPS 100 is also illustrated with network interface device (NID) 150 coupled to system bus 110. NID 150 enables DPS 100 to connect to one or more remote servers 165 (such as, host systems 102, 103) via access networks 170, such as the Internet.

In the described embodiments, when access network 170 is the Internet, access network 170 represents a worldwide collection of networks and gateways that utilize the Transmission Control Protocol/Internet Protocol (TCP/IP) suite of protocols to communicate with one another. Of course, network access may also be provided via a number of different types of networks, such as an intranet, an Ethernet, a Local Area Network (LAN), a Virtual Private Network (VPN), or other Wide Area Network (WAN) other than the Internet, for example.

Notably, in addition to the above described hardware components of DPS 100, various features of the invention are completed via software (or firmware) code or logic stored within system memory 115, in other storage (e.g., intermediate system disk 117), or stored remotely in memory of server 165 and executed by CPU 105. System memory 115 is defined as a lowest level of volatile memory (not shown), including, but not limited to, cache memory, registers, and buffers. In one embodiment, data/instructions/code stored in remote memory of remote server 165 populates the system memory 115. In another embodiment, the data/instructions/code are stored and executed remotely from remote server 165 and accessed by DPS 100 via NID 150.

Thus, illustrated within system memory 115 are a number of software/firmware components, including operating system (OS) 130 (e.g., Microsoft Windows®, a trademark of Microsoft Corp; or GNU®/Linux®, registered trademarks of the Free Software Foundation and Linus Torvalds; or Advanced Interactive eXecutive—AIX®—, registered trademark of International Business Machines—IBM), applications 135, and Basic Input/Output System (BIOS) 140. Illustrated within system memory 115 is Command Ordering and Execution (COE) utility 145. For simplicity, COE utility 145 is illustrated and described as a stand alone or separate software/firmware component, which is stored in system memory 115 to provide/support the specific novel functions described herein. Nevertheless, it should be appreciated that COE utility 145 can be stored outside of system memory 115, according to another embodiment.

CPU 105 executes COE utility 145 as well as OS 130, which supports the user interface features of COE utility 145. In the illustrative embodiment, COE utility 145 facilitates ordering of commands within intermediate system disk 117. Among the software code/instructions provided by COE utility 145, and which are specific to the invention, are code for: (a) selecting a command group from a command queue; (b) determining whether the command group includes a write command for writing an entire hologram segment; (c) responsive to a determination that the command group includes the write command for writing the entire hologram segment, writing the entire hologram segment; (d) responsive to a determination that the command group does not include the write command for writing the entire hologram segment, reading the entire hologram segment to an intermediate system disk; (e) sorting conflicting commands from non-conflicting commands; (f) executing all non-conflicting commands; (g) executing all conflicting write commands; (h) responsive to the execution completion all conflicting write commands, executing all conflicting read commands; (i) closing the entire hologram segment of the intermediate system disk; and (j) writing the entire hologram segment in a holographic medium.

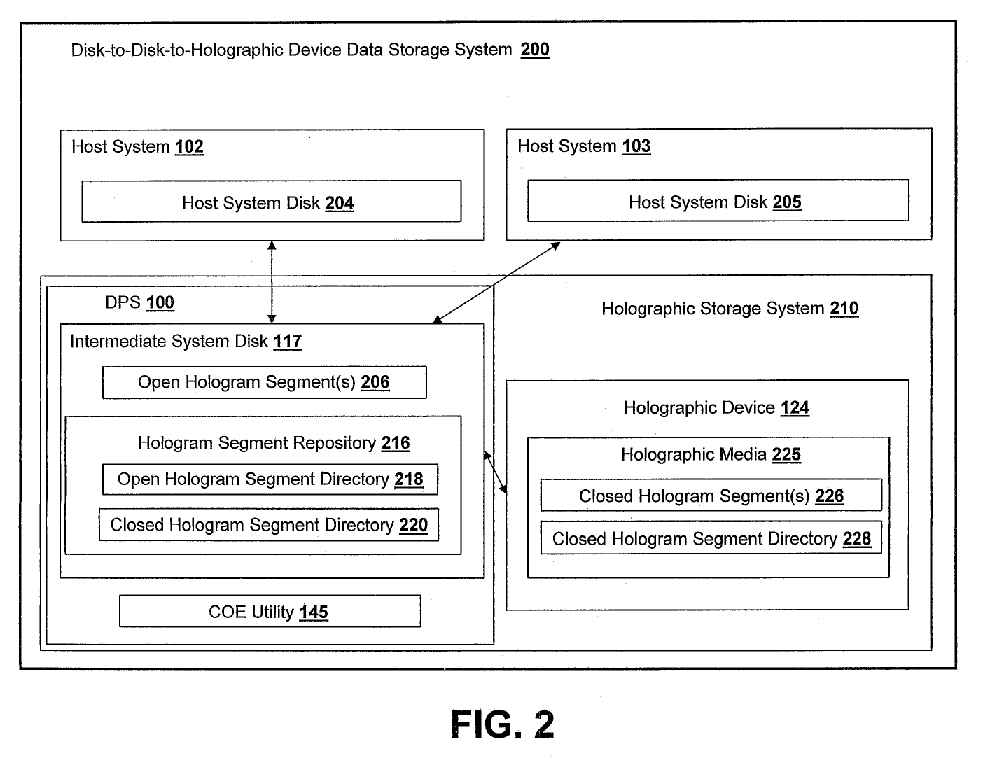

For simplicity of the description, the collective body of code that enables these various features is referred to herein as COE utility 145. According to the illustrative embodiment, when CPU 105 executes COE utility 145, DPS 100 initiates a series of functional processes that enable the above functional features as well as additional features/functionality, which are described below within the description of FIGS. 2-4.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM System p5™ (a trademark of International Business Machines—IBM), a product of International Business Machines Corporation in Armonk, N.Y., running the AIX® operating system or LINUX® operating system.

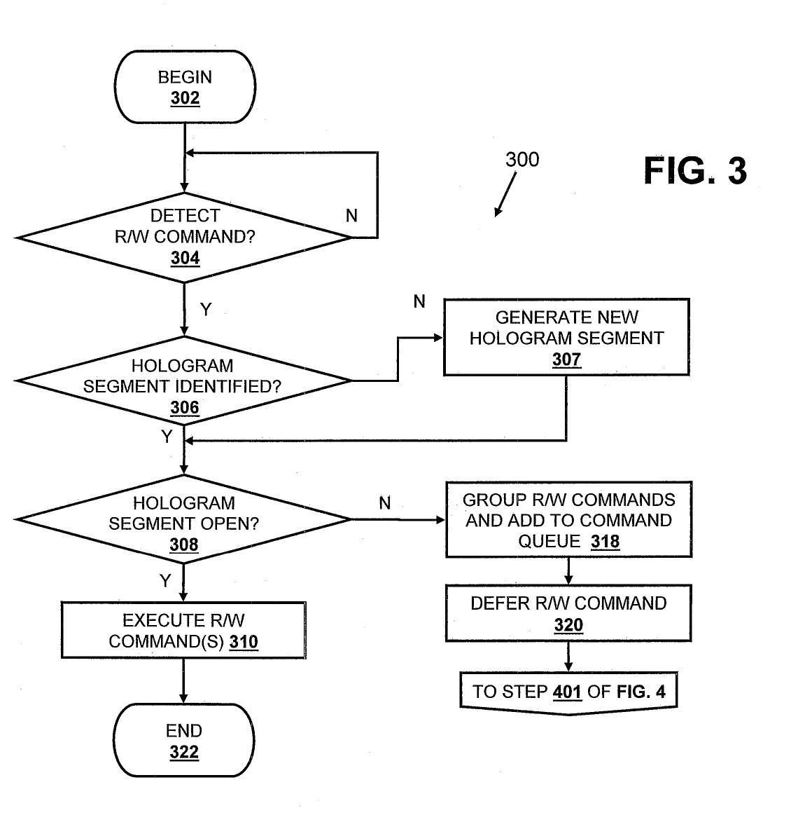

Within the descriptions of the figures, similar elements are provided similar names and reference numerals as those of the previous figure(s). Where a later figure utilizes the element in a different context or with different functionality, the element is provided a different leading numeral representative of the figure number (e.g., 2xx for FIGS. 2 and 3xx for FIG. 3). The specific numerals assigned to the elements are provided solely to aid in the description and not meant to imply any limitations (structural or functional) on the invention.

With reference now to FIG. 2, there is depicted an exemplary host-Disk-to-intermediate-Disk-to-Holographic (D2D2H) data storage system 200. System 200 includes host systems 102, 103, which read and write data to holographic storage system 210 using a read command and a write command, respectively. As shown, there can be more than one host system 102, 103 connected to holographic storage system 210. The read and write commands can include, but are not limited to: Small Computer System Interface (SCSI) commands, Internet SCSI (iSCSI) commands, Global-built Environmental Network (GbEN) commands, or any other operation that reads and writes data from host system(s) 102, 103 to holographic storage system 210. Host systems 102, 103 respectively employ host system disks 204 and 205 to store data (i) before the data is written to and/or (ii) after the data is read from intermediate system disk 117. Within DPS 100, intermediate system disk 117 is associated with holographic storage system 210. Host system disks 204, 205 and intermediate system disk 117 can include, but are not limited to (a) semiconductor memory, or (b) DVD, HD-DVD, Blu-Ray, phase-change, or magneto-optical disks. Holographic storage system 210 also includes holographic device 124, which is used to read and write data to holographic media 225.

When data is written from host system 102, 103 to holographic storage system 210, the data is initially stored in open hologram segment(s) 206 residing on and maintained by intermediate system disk 117. Open hologram segment(s) 206 is an area of non-volatile memory with equal or greater data storage capacity than closed hologram segment(s) 226 stored on holographic media 225. Intermediate system disk 117 includes hologram segment repository 216, which stores and maintains one or more open hologram segment directories 218. Each open hologram segment directory 218 records a reference to the data stored in corresponding open hologram segment 206. The references to the data can include a block address or a file name.

Hologram segments, which include open hologram segment(s) 206 and closed hologram segment(s) 226, can have one of two storage states: open or closed. Open hologram segment 206 resides in intermediate system disk 117 and the data contained in open hologram segment 206 is accessible by host system(s) 102, 103. When open hologram segment 206 reaches data storage capacity, open hologram segment 206 may be migrated to holographic media 225 as closed hologram segment 226. As a result, open hologram segment 206 may be removed from intermediate system disk 117, and the data stored in closed hologram segment 226 is not accessible on intermediate system disk 117. Alternatively, open holographic segment(s) 206 may be left open when it reaches storage capacity if further updates are expected or it is anticipated that open hologram segment(s) 206 will be accessed for reading. If open hologram segment(s) 206 is anticipated to be read, open hologram segment(s) 206 will be migrated later either due to inactivity in order to free space on intermediate system disk 117 or by an explicit command from host system 102, 103 to close open hologram segment 206.

In addition, when open hologram segment 206 is migrated to holographic media 225, open hologram segment directory 218 is copied to holographic media 225 as closed hologram segment directory 228. Closed hologram segment directory 228 references the data stored in corresponding closed hologram segment 226. In addition to the closed hologram segment directory 228 residing on holographic media 225, a copy of closed hologram segment directory 228 remains in intermediate system disk 117 as closed hologram segment directory 220. Open hologram segment directory 218, which was migrated to closed hologram segment directory 228, may be removed from intermediate disk 117 whenever the associated open hologram segment 206 is removed. Open hologram segment directory 218 and closed hologram segment directory 220 reside in hologram segment repository 216, such that hologram segment repository 216 serves as a central catalog for both open hologram segment(s) 206 and closed hologram segment(s) 226. Usage of hologram segment repository 216 as a single source is advantageous when more than one host system disk 204, 205 is connected to intermediate system disk 117.

Open hologram segment(s) 206 and open hologram segment directory 218 are respectively identical in data content to closed hologram segment(s) 226 and closed hologram segment directory 228 stored on holographic media 225. As long as no write commands are received from host system(s) 102, 103 to closed hologram segment 226, closed hologram segment 226 is maintained in a closed state and will not be opened (i.e., migrate back to intermediate system disk 117 as open hologram segment 206). However, if a write command is received from host system 102, 103 that modifies the contents of closed hologram segment 226, then closed hologram segment 226 is opened. When closed hologram segment 226 is opened, corresponding closed hologram segment directory 228 migrates to intermediate system disk as open hologram segment directory 218.

When host system 102, 103 reads from holographic storage system 210, host system 102, 103 sends a read command that includes a reference to the data to be read from holographic storage system 210. Based on the reference to the data to be read, holographic storage system 210 determines whether the data to be read resides in open hologram segment 206 of intermediate system disk 117, or in closed hologram segment(s) 226 of holographic media 225. For open hologram segment 206, holographic storage system 210 utilizes the reference data stored in hologram segment repository 216. For closed hologram segment 226, holographic storage system 210 utilizes the closed hologram segment directory 220 stored in hologram segment repository 216.

If the data to be read resides in open hologram segment 206, holographic storage system 210 returns the requested read data to host system 102, 103 directly from open hologram segment 206 residing on intermediate disk 117. Otherwise, if the requested read data reside in closed hologram segment 226, holographic storage system 210 accesses holographic media 225 via holographic device 124 and reads the data of closed hologram segment 226 to intermediate system disk 117. In this regard, holographic device 124 supports the option of reading the entire portion of closed hologram segment 226, or reading select portions of closed hologram segment 226. When reading closed hologram segment 226 from holographic media 225 to intermediate system disk 117, the state of closed hologram segment 226 is changed to open and the data contents of closed hologram segment 226 are copied to open hologram segment 206. Alternatively, the data can be read directly from closed hologram segment 228 residing on the holographic media 225 without being restored on intermediate system disk 117. In the case where the data is read directly from closed hologram segment 228, the closed state of closed hologram segment(s) 226 is unchanged. Moreover, open hologram segment directory 218 and closed hologram segment directory 220 can be stored in a database structure (not shown) represented by hologram segment repository 216 to enable faster queries on intermediate system disk 117.

A plurality of host systems 102, 103 can be employed in reading from or writing to holographic storage system 210. In this regard, host systems 102 and 103 can share the same open holographic segment 206 for reading/writing commands. Alternatively, each host system 102, 103 of a multiple host system can have a separate open holographic segment 206 residing in intermediate system disk 117. Moreover, multiple concurrent read and write commands may be sent by host systems 102, 103 to holographic storage system 210 for one or more open hologram segments 206 and/or closed hologram segment(s) 226. Closed hologram segment(s) 226 reside on holographic media 225. In the case of multiple host systems 102, 103, COE utility 145 resides in intermediate system disk 117 since all host systems 102, 103 communicate with intermediate system disk 117. DPS 100 is a platform from which COE utility 145 is executed.

Command ordering for reading data from and writing data to holographic storage system 210 is based on several policies. First, read and write commands to and from open hologram segments 206 are queued immediately and executed based upon the queuing priority. Second, read commands to the same “open” hologram segment 206 or to the same “closed” hologram segment 226 can be logically grouped such that the physical read operation satisfies the plurality of read commands to the same hologram segment. However, the read commands, when received within a predefined period, can be logically grouped as long as there are no intervening write commands to the same hologram segment to which the plurality of read commands are to be logically grouped.

A third policy that is followed in COE utility 145 is that read and write commands to adjacent open hologram segments 206 and/or to adjacent closed hologram segments 226 on the same holographic media 225 may be grouped sequentially such that the physical read or write operations are most efficiently executed. This third policy is valid as long as: (i) the read and write commands are received within a predefined time period and (ii) the second policy (discussed earlier) is not violated.

According to one embodiment, read/write commands addressing the same hologram segment are grouped. As a result, the timely order of the commands is maintained. Based on the policies discussed above, read/write commands pertaining to one group (i.e., the read/write commands reference the same hologram segment) represent one command group or command queue entry. The command queue is usually processed in a First-In-First-Out (FIFO) manner.

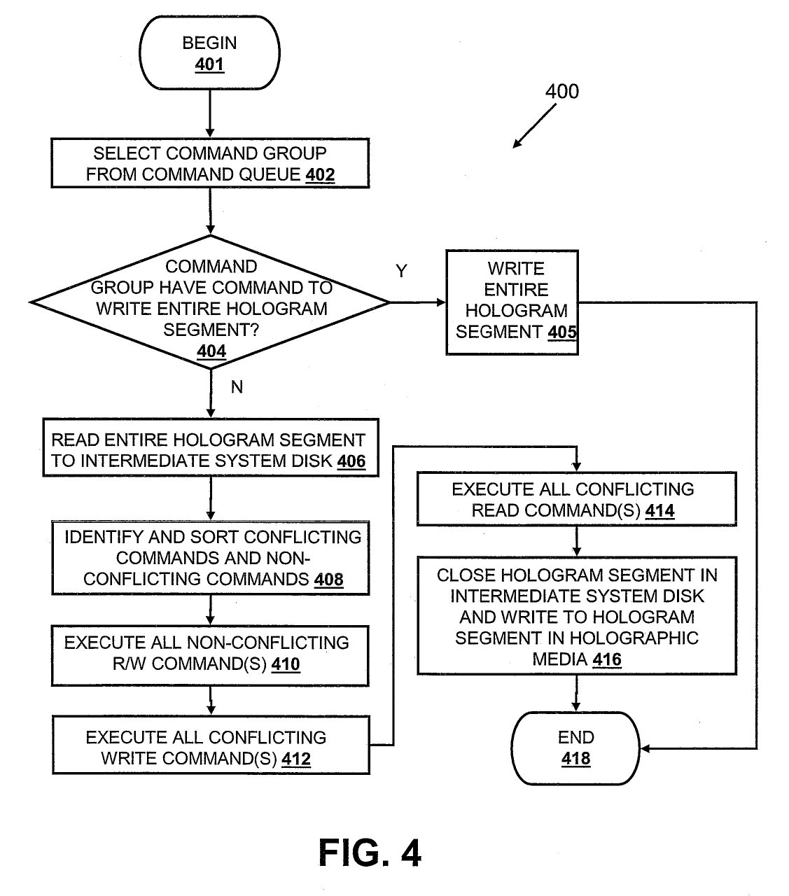

With general reference to FIGS. 3-4, exemplary method steps of COE utility 145 (FIGS. 1 and 2) are shown. Referring now to FIG. 3, a flow chart of the command ordering method 300 is illustrated. Method 300 starts in block 302 and continues to decision block 304 in which a determination is made whether COE utility 145 has detected a read or write (R/W) command from host system 102, 103 (FIG. 2). If a R/W command is not detected, method 300 continues in decision block 304 until a R/W command is detected. The R/W command includes: (i) a data reference (i.e., an address) to the data that is stored (in the case of a read command), or (ii) a data reference to where the data should be stored (in the case of a write command). The data reference can point to either open hologram segment 206 (FIG. 2) or closed hologram segment 226 (FIG. 2). If a R/W command is detected, a determination is then made whether the associated hologram segment 206, 226 is identified in block 306. The associated hologram segment is identified based on the: (i) input data from host system 102, 103, (ii) hologram segment addressed by the R/W command, and (iii) holographic medium 225 (FIG. 2) that stores closed hologram segment addressed by the R/W command.

If no hologram segment is identified in decision block 306, then the R/W command will generate a new open hologram segment, as depicted in block 307. Once a new hologram segment has been generated or a hologram segment has been identified, method 300 continues to decision block 308. At decision block 308, a determination is made whether the identified hologram segment is open and thus accessible to a R/W command. If the answer to decision block 308 is “Yes”, method 300 continues to block 310 where the command is executed. From block 310, method 300 continues to termination block 322.

If the identified hologram segment is closed (i.e., not accessible by R/W command), method 300 continues from block 308 to block 318 where the R/W commands are grouped and added to the command queue. In this regard, the R/W commands addressing the same hologram segment are grouped into one command group per hologram segment and added to a command queue, whereby the timely order for each command group is maintained within the command queue. From block 318, method 300 continues to block 320 where the execution of R/W command is deferred. Command execution can be deferred in block 320 by protocol-specific communication between host system(s) 102, 103 and holographic storage system 210. In one example, the Small Computer System Interface (SCSI) protocol can provide a way to disconnect communication with host system(s) 102, 103. From block 320, method 300 continues to block 401 of FIG. 4, which describes the execution of commands within a command group that references a closed command segment.

R/W commands are being grouped with other R/W commands that reference the same closed hologram segment 226 according to block 318. All commands referencing the same closed hologram segment 226 are grouped and represented as a single command queue entry. In addition, a time stamp indicating when the command was detected in decision block 304 is added to the command queue for each command or command group. Among the commands pertaining to the same closed hologram segment 226, the time stamp of the oldest command is representative of the particular command group. Adding a time stamp to a command queue entry (i.e., commands or command groups) facilitates the identification of the oldest command in the queue, as well as the identification of the aggregate queue time for all commands in a command group. In this regard, a command group can be selected based on whether the aggregate queue time for all commands in a command group is the highest aggregate queue time of all other command groups. In addition, the time stamp allows for the deferred execution of a command for a predetermined period of time. Specifically, the time stamp can be used to determine whether additional commands can be accepted for grouping in accordance to a predefined time period for deferral. However, the total aggregate queue time for a command group is one of several important factors in the execution of commands within a command group. According to another embodiment, command groups can be prioritized based on the total number of pending commands, irrespective of the time stamps associated with those pending commands.

Referring now to FIG. 4, method 400 for executing commands within a command group is shown. Method 400 begins at block 401 and continues to block 402, in which a command group is selected from a command queue. In this regard, the command group that is selected is based upon the command group having the highest total number of pending commands within the command group. The command group includes read and write commands to data blocks or data objects residing in closed hologram segment 226. Method 400 continues to decision block 404, where a determination is made whether the command group includes a write command to write an entire hologram segment 226. If the command group includes a write command to write an entire hologram segment 226, the write command will be executed as depicted in block 405, and the process 400 ends at termination block 418.

If there is no R/W command to write an entire hologram segment 226, method 400 continues to block 406, where the entire hologram segment 226 is read to intermediate system disk 117 and the data contents of closed hologram segment 226 are copied to open hologram segment 206. From block 406, method 400 continues to block 408 where COE utility 145 identifies and separates/sorts non-conflicting commands in the command group from conflicting commands in the command group. As used herein, conflicting commands are commands of opposite type (i.e., read and write commands) which address the same data address or data object referencing open hologram segment 206. Once the conflicting and non-conflicting commands have been sorted, all of the non-conflicting R/W command(s) are executed in the order in which they appear in the execution queue, as depicted in block 410.

After executing all non-conflicting commands, method 400 continues to block 412, in which all conflicting write commands are executed. Subsequent to executing all conflicting write commands, all conflicting read commands are then executed, as depicted in block 414. By executing all conflicting write commands before all conflicting read commands, host system(s) 102, 103 are ensured that the data that are retrieved by host system(s) 102, 103 are the most recent data. After the execution of conflicting and/or non-conflicting commands, open hologram segment 206 of intermediate system disk 117 is closed and the data contained in open hologram segment 206 are written to closed hologram segment 226 in holographic media 225, as depicted in block 416. Method 400 ends at termination block 418.

In the flow charts (FIGS. 3-4) above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the exemplary method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the exemplary method steps in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device to another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teaching of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a computing device, a method for command execution within a command group for a host-Disk-to-intermediate-Disk-to-Holographic (D2D2H) data storage system, the method comprising:
selecting said command group from a command queue;
responsive to a determination that said command group does not include a write command for writing an entire hologram segment, reading said entire hologram segment to an intermediate system disk;
sorting conflicting commands in said command group from non-conflicting commands in said command group;
executing conflicting write commands in said command group; and
executing conflicting read commands in said command group after completion of said executing said conflicting write commands in said command group.

2. The method of claim 1, wherein said command group is selected based on the total number of pending commands in said command group.

3. The method of claim 1, wherein said command group is selected based on the highest aggregate queue time for all commands in said command group.

4. The method of claim 1, further comprising:
determining whether said command group includes said write command for writing an entire hologram segment; and
responsive to a determination that said command group includes said write command for writing said entire hologram segment, writing said entire hologram segment.

5. The method of claim 1, further comprising executing said non-conflicting commands in said command group.

6. The method of claim 1, further comprising:
closing said entire hologram segment of said intermediate system disk; and
writing said entire hologram segment in a holographic medium.

7. A computer program product comprising:
a computer storage medium; and
program code on the computer storage medium that when executed provides the functions of:
selecting a command group from a command queue;
responsive to a determination that said command group does not include a write command for writing an entire hologram segment, reading said entire hologram segment to an intermediate system disk;
sorting conflicting commands in said command group from non-conflicting commands in said command group;
executing conflicting write commands in said command group; and
executing conflicting read commands in said command group after completion of said executing said conflicting write commands in said command group.

8. The computer program product of claim 7, wherein said command group is selected based on the total number of pending commands in said command group.

9. The computer program product of claim 7, wherein said command group is selected based on the highest aggregate queue time for all commands in said command group.

10. The computer program product of claim 7, wherein the program code further provides the functions of:
determining whether said command group includes said write command for writing an entire hologram segment; and
responsive to a determination that said command group includes said write command for writing said entire hologram segment, writing said entire hologram segment.

11. The computer program product of claim 7, wherein the program code further provides the function of executing said non-conflicting commands in said command group.

12. The computer program product of claim 7, wherein the program code further provides the functions of:
closing said entire hologram segment of said intermediate system disk; and
writing said entire hologram segment in a holographic medium.

13. A data processing system comprising:
a processor;
a host-Disk-to-intermediate-Disk-to-Holographic (D2D2H) data storage system coupled to said processor:
a command ordering and execution (COE) utility executing on the processor and having executable code for:
selecting a command group from a command queue;
responsive to a determination that said command group does not include a write command for writing an entire hologram segment, reading said entire hologram segment to an intermediate system disk;
sorting conflicting commands in said command group from non-conflicting commands in said command group;
executing conflicting write commands in said command group; and
executing conflicting read commands in said command group after completion of said executing said conflicting write commands in said command group.

14. The data processing system of claim 13, wherein said command group is selected based on the total number of pending commands in said command group.

15. The data processing system of claim 13, wherein said command group is selected based on the highest aggregate queue time for all commands in said command group.

16. The data processing system of claim 13, the COE utility further having executable code for:
determining whether said command group includes said write command for writing an entire hologram segment; and
responsive to a determination that said command group includes said write command for writing said entire hologram segment, writing said entire hologram segment.

17. The data processing system of claim 13, the COE utility further having executable code for executing said non-conflicting commands in said command group.

18. The data processing system of claim 13, the COE utility further having executable code for:
closing said entire hologram segment of said intermediate system disk; and
writing said entire hologram segment in a holographic medium.
